(19) United States
(12) Patent Application Publication
(10) Pub. No.: US 2005/0015483 A1
(43) Pub. Date: Jan. 20, 2005

(54) Method and apparatus for managing display of dialogs in computing devices based on device proximity

(75) Inventors: William Stephen Carter, Round Rock, TX (US); Herman Rodriguez, Austin, TX (US); Hypatia Rojas, Round Rock, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/460,457

(22) Filed: Jun. 12, 2003

(51) Int. Cl. G06F 15/16

(52) U.S. Cl. 709/224; 709/229

(57) ABSTRACT

A method in a user computing device for presenting dialogs in a set of computing devices including the user computing device. Responsive to a request to present a dialog, computing devices within the set of computing devices in a selected proximity of the user computing device are identified to form a set of proximate computing devices. The dialog is presented on only one of the user computer device and the set of proximate computing devices based on a policy.

### BACKGROUND OF THE INVENTION

1. Technical Field

The present invention relates generally to an improved data processing system and in particular, to a method and apparatus for managing presentation of data. Still more particularly, the present invention provides a method, apparatus, and computer instructions for managing presentation of dialogs in a set of devices.

2. Description of Related Art

Computing devices take many different forms. Computing devices may be, for example, a workstation, a laptop, a personal digital assistant (PDA), and a digital or mobile phone. Larger devices, such as workstations and personal computers provide large amounts of storage and computing power. Smaller computing devices, such as a PDA or mobile phone, do not have as much processing power or storage. These types of devices, however, provide portability and convenience for the user.

Users often keep databases of addresses and appointments. With portable computing devices, such as PDAs and mobile phones, a user is able to carry information, such as addresses and appointments on these devices to allow for easy access to this type of information. As users make changes while carrying these portable computing devices, the changes may be synchronized to databases located on less portable computing devices, such as a personal computer. In this manner, a user may have an up-to-date database of information on several computing devices.

One program frequently used is a calendar program. A user may create events that are stored for later review. Further, with an event, a reminder option may be created for this event. This reminder option causes the calendar program to present a pop-up dialog at a predetermined time prior to the event to remind the user of the upcoming event. However, given the availability of multiple computing devices, the synchronization of information between these devices may result in all of the devices presenting a pop-up dialog for the user to acknowledge the event and possibly set a “snooze” reminder.

Having multiple reminders requiring an acknowledgment provides a usability problem for a user because the user must repeatedly acknowledge the same reminder on different computing devices. Therefore, it would be advantageous to have an improved method, apparatus, and computer instructions for providing only a single reminder to the user.

### SUMMARY OF THE INVENTION

The present invention provides a method in a user computing device for presenting dialogs. Responsive to a request to present a dialog, an identification is made of computing devices within the set of computing devices in a selected proximity of the user computing device to form a set of proximate computing devices. This identification may be made during different times. For example, the identification may occur when a communications link is established or during synchronization of data. The dialog is presented only on one of the user computing device and the set of proximate computing devices based on a policy.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIGS. 1A-1C are diagrams illustrating computing devices used in providing a single reminder to a user in accordance with a preferred embodiment of the present invention;

FIG. 2 is a block diagram of a computing device in which the present invention may be implemented;

FIG. 3 is a block diagram of a computing device in the a form of a PDA in accordance with a preferred embodiment of the present invention;

FIG. 4 is a diagram illustrating components used to manage presentation of dialogs in computing devices in accordance with a preferred embodiment of the present invention;

FIG. 5 is a flowchart of a process for handling a request to display a dialog in accordance with a preferred embodiment of the present invention;

FIG. 6 is a flowchart of a process for managing acknowledgment of a reminder in accordance with a preferred embodiment of the present invention; and

FIG. 7 is a flowchart of a process for managing reminder events in accordance with a preferred embodiment of the present invention.

### DETAILED DESCRIPTION OF THE PREFERRED EMBODIMENT

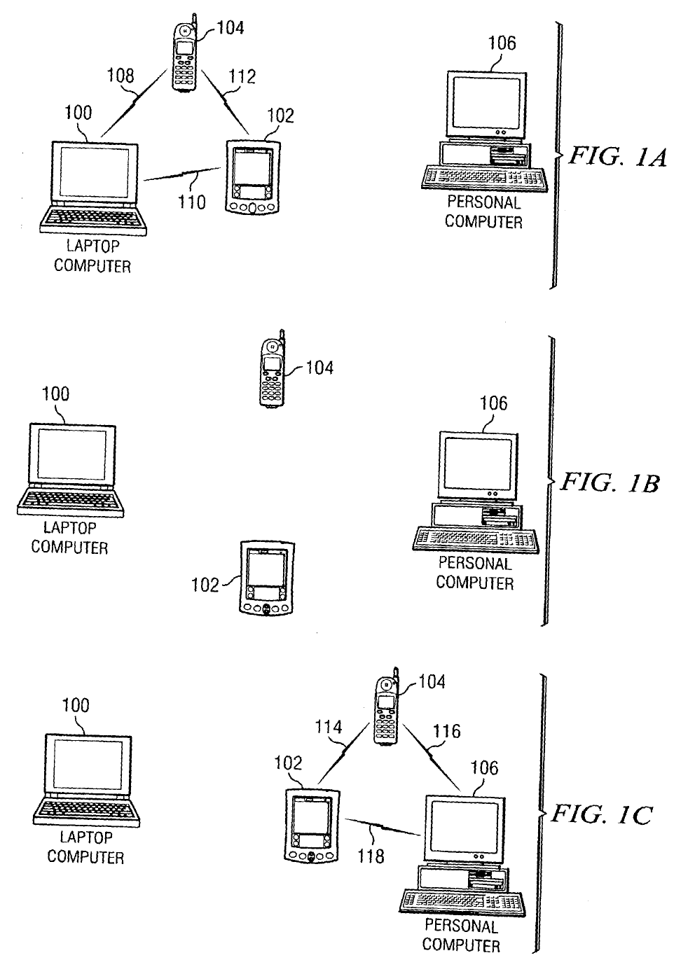

With reference now to the figures, and in particular, with reference to FIGS. 1A-1C, diagrams illustrating computing devices used in providing a single reminder to a user are depicted in accordance with a preferred embodiment of the present invention. In FIG. 1A, laptop computer 100, personal digital assistant 102, and digital phone 104 are all in communication with one another, while not in communication with personal computer 106. Laptop computer 100, PDA 102, and digital phone 104, are in communication with each other through communications links 108, 110, and 112.

In these examples, these communications links are wireless links. These wireless links may follow various protocols. In this example, these links are established using Bluetooth, which is a standard developed by a group of electronics manufacturers that allows any sort of electronic equipment, from computers and cell phones to keyboards and headphones, to make its own connections, without wires, cables or any direct action from a user. The standard and specification for Bluetooth is set by the Bluetooth Special Interest Group. Depending on the particular implementation, other types of wireless connections may be employed, such as infrared or IEEE 802.11b, also known as Wi-Fi.

As described, each of these computing devices includes a calendar program, as well as calendar data for the calendar program. This calendar data includes events, as well as reminder options set for one or more of the events. For example, one event may be a meeting at 9:00 a.m. The reminder option for the event may generate a pop-up dialog thirty minutes prior to the meeting. This event may be initially set or calendared on one computing device, such as personal computer 106. This event is synchronized with PDA 102 prior to the establishment of these communications links in this example.

When laptop computer 100, laptop computer 100, and digital phone 104 are in communication with each other, these devices are able to synchronize the calendar data. In particular, the event for the meeting may be propagated to calendar data in PDA 102 and digital phone 104 when the calendar data is synchronized between these computing devices. As a result, when a reminder is presented, normally this reminder is presented on all three of these devices. As a result, the user would be required to acknowledge the event or set the snooze option on all of the devices.

The present invention provides a method, apparatus, and computer instructions for providing a mechanism to present the reminder only on one of the computing devices. In these examples, the dialogs are presented on a computing device only if the user is in proximity to acknowledge the dialog. The mechanism of the present invention allows a user to create a hierarchy of response computing devices based on proximity, such that the reminder is presented only on the highest priority device.

In one example, the user may select a priority for devices such that a dialog is presented on personal computer 106, if either laptop computer 100, PDA 102, or digital phone 104 are in proximity of personal computer 106. A second lower priority is if either PDA 102 or digital phone 104 is within proximity of laptop computer 100, a dialog is presented on laptop computer 100. Another priority that is set in this example is that dialogs are presented on PDA 102 if digital phone 104 is in proximity of PDA 102. If neither laptop computer 100 nor PDA 102 is in proximity of digital phone 104, then dialogs are presented on PDA 102 and digital phone 104. In this example, two dialogs are present on two devices. These are dialogs that are outstanding waiting for an acknowledgment. If either one of the dialogs is acknowledged and the devices come within proximity of each other, then the dialogs are synchronized. The dialog that is not acknowledged is automatically dismissed because the other dialog has been acknowledged.

PDA 102 and digital phone 104 are considered to be in proximity of laptop computer 100 if a communications link is established with these devices. The proximity may be established based on a distance or range between the devices, the establishment of a communications link between the devices, or when the devices communicate with each other, such as during synchronization of data. If the devices cannot communicate with each other, then they are not considered within proximity of each other.

In FIG. 1A, a dialog is presented on laptop computer 100, while no dialogs are presented on PDA 102, digital phone 104, and personal computer 106. Personal computer 106 does not present a dialog because this device is not in communication with any of the other devices set in the priority scheme. Dialogs are presented on laptop computer 100 in this example, while suppressed on the other devices.

In FIG. 1B, none of the computing devices are in communication with each other. Digital phone 104 and PDA 102 are carried by a user out of communication range of laptop computer 100 and personal computer 106. PDA 102 is turned off. In this situation, dialogs are presented on digital phone 104. If PDA 102 was turned on and in communication with digital phone 104, then dialogs would be presented on PDA 102.

Next, in FIG. 1C, PDA 102, digital phone 104, and personal computer 106 are in communication with each other through communications links 114, 116, and 118. If the meeting event was acknowledged, personal computer 106 will not present a dialog because the setting of this snooze option was communicated by one or both of PDA 102 and digital phone 104 when data is synchronized between the computing devices. If the computing devices are not presently connected or in communication with each other, the dialog is presented on all of the computing devices. When the computing devices are in proximity with each other, such as in communication or performing synchronization, the dialogs for all computing devices are dismissed if that dialog was acknowledged on any of the disconnecting computing devices. If no acknowledgment has been acknowledged, then the dialog is presented on one of the devices based on a priority scheme in these examples.

In this manner, the present invention provides a mechanism to allow overriding of dialogs based on the proximity of a computing device to other computing devices. The name of the device that allows or initiates the override of dialogs may be discovered when a discovery process occurs. Data identifying other devices and their priorities may be saved in each of the devices by this process.

In these examples, a hierarchy of override devices may be set. For example, the hierarchy may be as follows: personal computer 106, laptop computer 100, PDA 102, and digital phone 104 with personal computer 106 being the highest on the hierarchy and digital phone 104 being the lowest on the hierarchy. With this hierarchy, digital phone 104 does not present a dialog if laptop computer 100 is in proximity of digital phone 104. Similarly, digital phone 104 does not present a dialog if PDA 102 is in proximity. Instead, the dialog is presented on PDA 102. A dialog is presented on laptop computer 100 instead of PDA 102 if PDA 102 is in proximity of laptop computer 100. A dialog is presented on personal computer 106 when PDA is in proximity of personal computer 106. Personal computer 106 is considered an override device with respect to laptop computer 100.

These priorities and hierarchies may be set using a policy that is implemented or stored in the different devices. Many different hierarchies or rules for what devices override other devices may be set depending on the particular implementation. Further, the dialog handling mechanism of the present invention may be implemented with other numbers and/or types of computing devices other than those illustrated. For example, the override mechanism of the present invention may be implemented only between digital phone 104 and laptop computer 100.

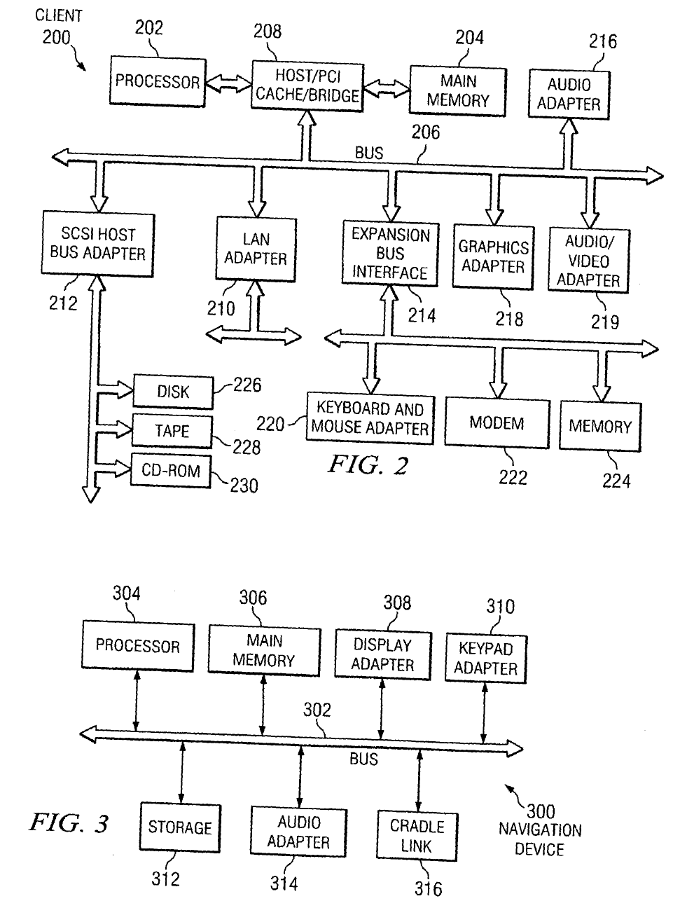

With reference now to FIG. 2, a block diagram of a computing device is shown in which the present invention may be implemented. Computing device 200 is an example of a computer, such as laptop computer 100 or personal computer 106 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within computing device 200 in FIG. 2. The operating system may be a commercially available operating system such as Windows XP, which is available from Microsoft Corporation. Instructions for the operating system and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, computing device 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface.

The depicted example in FIG. 2 and above-described examples are not meant to imply architectural limitations. Computing device 200 also may be a kiosk or a Web appliance.

The processes of the present invention are performed by processor 202 using computer implemented instructions, which may be located in a memory such as, for example, main memory 204, memory 224, or in one or more peripheral devices 226-230.

Turning now to FIG. 3 a block diagram of a computing device in the a form of a PDA is shown in accordance with a preferred embodiment of the present invention. PDA 300 is an example of a PDA, such as PDA 102 in FIG. 1, in which code or instructions implementing the processes of the present invention may be located. PDA 300 includes a bus 302 to which processor 304 and main memory 306 are connected. Display adapter 308, keypad adapter 310, storage 312, and audio adapter 314 also are connected to bus 302. Cradle link 316 provides a mechanism to connect PDA 300 to a cradle used in synchronizing data in PDA 300 with another data processing system. Further, display adapter 308 also includes a mechanism to receive user input from a stylus when a touch screen display is employed.

An operating system runs on processor 304 and is used to coordinate and provide control of various components within PDA 300 in FIG. 3. The operating system may be, for example, a commercially available operating system such as Windows CE, which is available from Microsoft Corporation. Instructions for the operating system and applications or programs are located on storage devices, such as storage 312, and may be loaded into main memory 306 for execution by processor 304.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3.

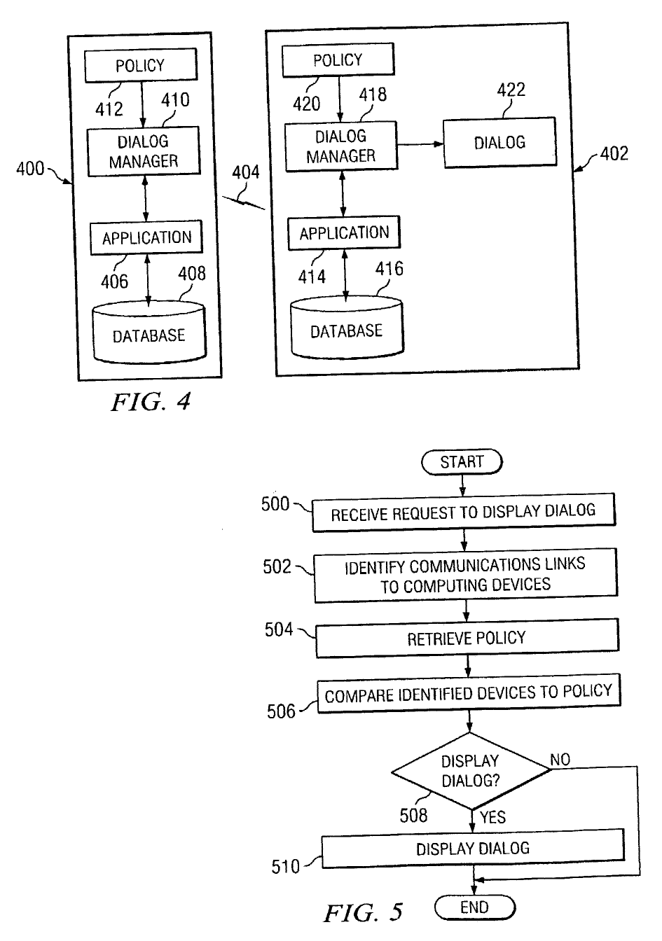

Turning next to FIG. 4, a diagram illustrating components used to manage presentation of dialogs in computing devices is depicted in accordance with a preferred embodiment of the present invention. In this example, computing device 400 and computing device 402 are illustrated as being in communication with each other through communications link 404.

Computing device 400 includes application 406, which accesses data in database 408. Although the mechanism of the present invention may be applied to any application that generates dialogs, in this example, application 406 is a calendar application, and database 408 is a database of events. Dialog manager 410 is the component that manages dialogs, including the override scheme of the present invention. Dialog manager 410 selectively displays dialogs in response to requests from applications, such as application 406. Policy 412 contains the data used to determine whether dialog 410 will display a dialog in response to a request from application 406. Computing device 402 contains application 414, database 416, dialog manager 418, and policy 420.

In this example, computing device 400 is a digital phone, while computing device 402 is a laptop computer. Computing device 402 is a device having a higher priority than computing device 400. Computing device 402 is considered as being the override device. These priorities are stored in policy 412 and policy 420.

Database 408 is synchronized with database 416. As a result, if an event stored in the databases includes an option for a reminder dialog, both application 406 and application 414 will make requests to dialog manager 410 and dialog manager 418 to present a dialog at the same time. Dialog manager 410 and dialog manager 418 will both search to see if another computing device is in proximity. In this example, proximity is present when a communications link is established between computing device 400 and computing device 402. Proximity also may be determined via device synchronization. Additionally proximity may be provided by another party, such as a telephone company providing information to a laptop indicating the location of the digital phone. Additionally, proximity may be based on location information obtained from a global positioning satellite (GPS) system. In such a case, coordinate ranges are identified and messages may be sent to the appropriate computing devices. Further, proximity may also be determined via other events, such as the time of day. For example, a policy may be created containing a rule in which the rule states that on Monday through Friday, the laptop computer and the PDA are within proximity of each other and that dialogs should be presented only on the laptop. In this case, the user inputs the proximity information. This type of proximity is also referred to as “static proximity” because the user inputs the condition of proximity. In these examples, proximity can also be established by determining whether the signal strength is greater than a selected amount. Even the CPU “noise” from other devices may be used to determine proximity.

Once computing device 400 and computing device 402 have discovered each other, dialog manager 410 checks policy 412, while dialog manager 418 checks policy 420 to determine whether a dialog should be presented in response to requests from an application. In this example, dialog manager 410 identifies computing device 402 as being an override device and does not present a dialog. Dialog manager 418 does not detect a device that has a higher priority. As a result, dialog 422 is presented to the user by device 402. Priorities or rules may be established in policy 412 for use in determining which computing device is to present a dialog. With priority, device use may be employed to set the priority. For example, if one computing device detects that the user is operating the computing device, such as a laptop, that computing device may inform other computing devices that the user is present at the laptop and that dialog should be presented only on the laptop.

If the user acknowledges the event, dialog 422 is closed. Dialogs may be displayed on all computing devices not within proximity of each other. In this case, if the user acknowledges any dialog on a computing device, then when all of the computing devices are within proximity of each other, all of the other dialogs for that event are automatically dismissed because of the acknowledgment of the dialog on one computing device by the user.

Thus, in this manner, dialogs are managed between multiple computing devices such that only a single dialog is presented to a user based on the proximity of computing devices to each other and priorities selected for the computing devices.

Turning next to FIG. 5, a flowchart of a process for handling a request to display a dialog is depicted in accordance with a preferred embodiment of the present invention. The process illustrated in FIG. 5 may be implemented in a process, such as dialog manager 410 in FIG. 4.

The process begins by receiving a request to display a dialog (step 500). The request is received from an application, such as application 406 in FIG. 4. In this example, the application is a calendar program requesting a dialog to be presented for a reminder. The process then identifies communications links to computing devices (step 502). This step is used to determine what other computing devices are in proximity. Thereafter, a policy is retrieved (step 504). The policy contains rules and/or priorities that are used to determine whether a dialog is to be presented.

Next, the identified devices are compared to the policies (step 506). Based on this comparison, a determination is made as to whether the dialog should be displayed (step 508). If the dialog is to be displayed, the display of the dialog is then initiated (step 510), with the process terminating thereafter. Otherwise, the process terminates without displaying the dialog on the computing device.

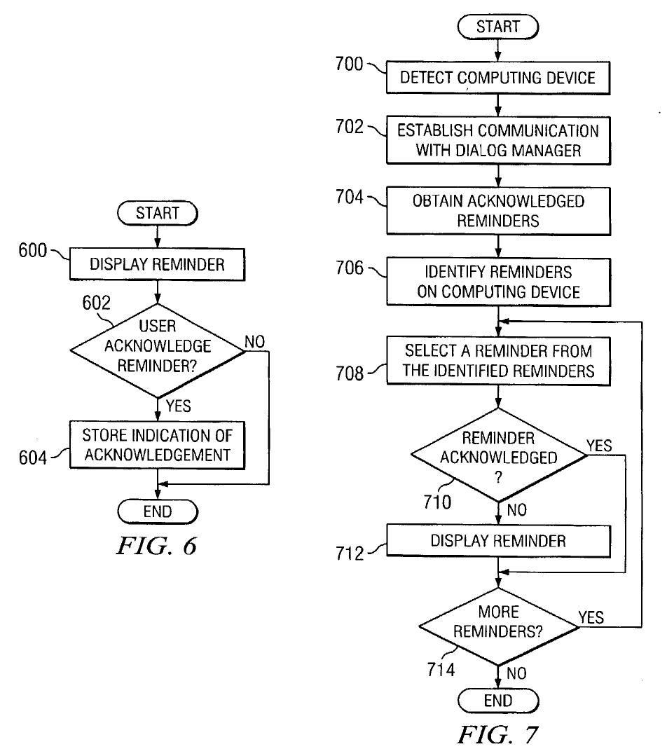

Turning next to FIG. 6, a flowchart of a process for managing acknowledgment of a reminder is depicted in accordance with a preferred embodiment of the present invention. The process illustrated in FIG. 6 may be implemented in a process, such as dialog manager 410 in FIG. 4. The process may be located in other locations too, such as in an application, the operating system, or even in firmware.

The process begins by displaying the reminder (step 600). A determination is made as to whether the user has acknowledged the reminder (step 602). If the user acknowledges the reminder, an indication of this reminder is stored (step 604), with the process terminating thereafter. With reference again to step 602, if the user does not acknowledge the reminder, the process terminates.

The process illustrated in FIG. 6 is used to handle acknowledgment of reminders across different computing devices. Acknowledgment of a reminder on one computing device is stored and communicated to other computing devices to indicate that the reminder is no longer needed.

Turning next to FIG. 7, a flowchart of a process for managing reminder events is depicted in accordance with a preferred embodiment of the present invention. The process illustrated in FIG. 7 may be implemented in a process, such as a dialog manager 410 in FIG. 4. The process begins by detecting a computing device (step 700). Communication is then established with a dialog manager on the other computing device (step 702). Thereafter, acknowledgments of reminders are obtained from the other computing device (step 704). Then, any reminders that are present in the system are identified (step 706). A reminder from the identified reminders is selected (step 708).

Then, a determination is made as to whether that reminder has been acknowledged (step 710). If the reminder has not been acknowledged, then the reminder is then displayed (step 712). A determination is then made as to whether additional reminders are present for processing (step 714). If additional reminders are present, then the process returns to step 708 to select another reminder. Otherwise the process terminates.

As a result, pending acknowledgments may be automatically dismissed when disconnected computing devices are presented with a dialog that was not acknowledged, but these computing devices come within proximity of a computing device on which the dialog has been acknowledged. In this manner, a single dialog acknowledgment is provided. Thus, the present invention provides a method, apparatus, and computer instructions for allowing dialogs to be presented only on a single computing device. The mechanism of the present invention overrides the display of dialogs on other computing devices that are in proximity to a selected computing device. In this manner, a user is able to see a single dialog without having to acknowledge the same dialog on multiple devices. The depicted examples illustrate the management of dialogs with respect to reminders for a calendar program. This mechanism of the present invention may be applied to any other application that displays dialogs with respect to data that is synchronized between computing devices. Additionally, the mechanism of the present invention has been illustrated as being implemented in a dialog manager process. This process may be implemented in various ways. For example, the process could be implemented as part of an operating system, a separate program, or part of an application, such as a calendar program.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a user computing device for presenting dialogs, the method comprising:
receiving a request to display a dialog;
identifying computing devices in proximity of the user computing device to form a set of proximate computing devices when the request is received; and
presenting the dialog on the user computer device unless an overriding computing device is present in the set of proximate computing devices.

2. The method of claim 1, wherein the data is synchronizable between the within set of computing devices.

3. The method of claim 1 further comprising:
determining whether which device in the set of proximate devices is the overriding computing device.

4. The method of claim 3, wherein the overriding computing device is determined based on a policy.

5. The method of claim 1, wherein user input is used to identify the overriding device.

6. The method of claim 1, wherein presentation of the dialog is prevented if a previous acknowledgment of an event for the dialog has occurred.

7. A method in a user computing device for presenting dialogs in a set of computing devices including the user computing device, the method comprising:
responsive to a request to present a dialog, identifying computing devices within the set of computing devices in a selected proximity of the user computing device to form a set of proximate computing devices; and
selectively presenting the dialog on the user computing device based on a policy, wherein the policy results in only of the user computing device and the set of proximate computing devices presenting the dialog.

8. The method of claim 7, wherein the policy includes priorities for the user computing device and the set of computing devices.

9. The method of claim 8, wherein the presenting step comprises:
determining whether the user computing device has a highest priority with respect to the set of proximate computing devices; and
responsive to the user computing device having the highest priority with respect to the set of proximate computing devices, displaying the dialog on the user computing device.

10. The method of claim 7, further comprising:
determining whether the dialog has been previously presented on one of the set of computing devices; and
responsive to a prior presentation of the dialog, preventing initiation of the presenting step.

11. The method of claim 7, wherein the set of computing devices include at least one of a laptop computer, a personal digital assistant, and a digital phone.

12. The method of claim 7, wherein the selected proximity occurs when wireless communication between the computing device and the set of computing devices is present.

13. The method of claim 7, wherein the dialog is for a reminder for a meeting.

14. A user computing device for presenting dialogs, the user computing device comprising:
receiving means for receiving a request to display a dialog;
identifying means for identifying computing devices within a set of computing devices in proximity of the user computing device to form a set of proximate computing devices when the request is received; and
presenting means for presenting the dialog on the user computer device unless an overriding computing device is present in the set of proximate computing devices.

15. The user computing device of claim 14, wherein the data is synchronizable between the within set of computing devices.

16. The user computing device of claim 14 further comprising:
second determining means for determining whether which device in the set of proximate devices is the overriding computing device.

17. The user computing device of claim 16, wherein the overriding computing device is determined based on a policy.

18. A user computing device for presenting dialogs in a set of computing devices including the user computing device, the user computing device comprising:
identifying means, responsive to a request to present a dialog, for identifying computing devices within the set of computing devices in a selected proximity of the user computing device to form a set of proximate computing devices; and
presenting means for selectively presenting the dialog on the user computing device based on a policy, wherein the policy results in only of the user computing device and the set of proximate computing devices presenting the dialog.

19. The user computing device of claim 18, wherein the policy includes priorities for the user computing device and the set of computing devices.

20. The user computing device of claim 19, wherein the presenting means comprises:
first means for determining whether the user computing device has a highest priority with respect to the set of proximate computing devices; and
second means, responsive to the user computing device having the highest priority with respect to the set of proximate computing devices, for displaying the dialog on the user computing device.

21. The user computing device of claim 18, further comprising:
second determining means for determining whether the dialog has been previously presented on one of the set of computing devices; and
preventing means, responsive to a prior presentation of the dialog, for preventing initiation of the presenting step.

22. The user computing device of claim 18, wherein the set of computing devices include at least one of a laptop computer, a personal digital assistant, and a digital phone.

23. The user computing device of claim 18, wherein the selected proximity occurs when wireless communication between the computing device and the set of computing devices is present.

24. The user computing device of claim 18, wherein the dialog is for a reminder for a meeting.

25. A user computing device comprising:
a bus system;
a memory connected to the bus system, wherein the
memory includes a set of instructions;
a processing unit connected to the bus system, wherein the processing unit executes the set of instructions to receive a request to display a dialog; identify computing devices within a set of computing devices in proximity of the user computing device to form a set of proximate computing devices when the request is received; and present the dialog on the user computer device unless an overriding computing device is present in the set of proximate computing devices.

26. A computer program product in a computer readable medium for presenting dialogs, the computer program product comprising:
first instructions for receiving a request to display a dialog;
second instructions for identifying computing devices within a set of computing devices in proximity of the user computing device to form a set of proximate computing devices when the request is received; and
third instructions for presenting the dialog on the user computer device unless an overriding computing device is present in the set of proximate computing devices.

27. A computer program product in a computer readable medium for presenting dialogs in a set of computing devices, the computer program product comprising:
first instructions, responsive to a request to present a dialog, for identifying computing devices within the set of computing devices in a selected proximity of a user computing device to form a set of proximate computing devices; and
second instructions for selectively presenting the dialog on the user computing device based on a policy, wherein the policy results in only of the user computing device and the set of proximate computing devices presenting the dialog.
